(19) United States
(12) Patent Application Publication
(10) Pub. No.: US 2025/0265376 A1
(43) Pub. Date: Aug. 21, 2025

(54) System Evaluation via Multiplex Network Science and Multiscale System Dynamics

(71) Applicants: Northeastern University, Boston, MA (US); Battelle Memorial Institute, Richland, WA (US); The Regents of the University of California, Oakland, CA (US)

(72) Inventors: Auroop Ratan Ganguly, Medford, MA (US); Marta Gonzalez, Berkeley, CA (US); Ariel Olaf Salgado, Berkeley, CA (US); Samrat Chatterjee, Richland, WA (US); Jack Robert Watson, Jamaica Plain, MA (US); Ashis Kumar Pal, Malden, MA (US)

(21) Appl. No.: 19/042,895

(22) Filed: Jan. 31, 2025

Related U.S. Application Data
(60) Provisional application No. 63/554,767, filed on Feb. 16, 2024.

(51) Int. Cl. G06F 30/13; G06F 111/02; G06F 113/04; G06Q 50/26

(52) U.S. Cl. CPC G06F 30/13; G06F 2111/02; G06F 2113/04; G06Q 50/26

(57) ABSTRACT

A multiplex network science (MNS) model represents infrastructure of an environment and an installation as a plurality of nodes connected by links, the links defining dependencies between the plurality of nodes. A multiscale system dynamics (MSD) model represents the installation as a plurality of nested subsystems and resource flows connecting the nested subsystems. A hybrid model integrating the MNS model and the MSD model is generated, the hybrid model linking the MNS model and MSD model via boundary conditions representing dependencies between the installation and the infrastructure of the environment. The hybrid model simulates an alteration to the infrastructure of the environment and propagation of effects of the alteration through at least one of the boundary conditions to the installation.

### RELATED APPLICATION

This application claims the benefit of U.S. Provisional Application No. 63/554,767, filed on Feb. 16, 2024. The entire teachings of the above application are incorporated herein by reference.

### GOVERNMENT SUPPORT

This invention was made with government support under Grant No. DE-AC05-76RL01830 awarded by the U.S. Department of Energy and Grant No. W912HQ21C0014 awarded by the U.S. Department of Defense. The government has certain rights in the invention.

### BACKGROUND

Installations like airports, military bases, and logistics hubs are increasingly exposed to disruptions like extreme weather and sea level rise, exacerbated by climate change, and manmade threats like targeted cyber-physical attacks. In the worst cases, more than one of these hazards may occur simultaneously or in close succession, which can have impacts greater than the sum of the two hazards in isolation. Furthermore, installations are reliant on the surrounding infrastructure environment to sustain functionality. Transportation, power, water, and communication networks are both critical for maintaining an installation and highly vulnerable to the aforementioned hazards.

### SUMMARY

Typically, either an installation or an infrastructure network is considered in resilience analysis. Modelling the two in isolation fails to capture the dependencies between them. Additionally, analysis frequently necessitates integrating data from different sources, often with different fidelities. For example, from the perspective of an installation stakeholder, detailed information on the internal operational dynamics of the installation may be available while detailed data on the surrounding power grid is not available due to security concerns. Highly heterogeneous data sources may result in a failure to leverage high-fidelity data in order to leverage low-fidelity data when using a single approach to resilience analysis.

To address these challenges, disclosed herein is a new approach to the resilience analysis of coupled installation-environment systems, referred to herein as Multiplex Network Science-Multiscale System Dynamics (MNS-MSD). Multiplex network science draws from a rich network science literature and concerns the analysis of the infrastructure networks surrounding an installation. MNS involves the simulation of network topology subject to disruptions and captures interdependencies between networks (e.g., transportation is needed to repair communications systems, while communications systems are needed to navigate transportation and coordinate repair). Complex behavior can be modelled without detailed information beyond the structure of the networks. Infrastructure networks connected to an installation determine the boundary conditions for MSD.

MSD models the interior of an installation as a dynamical system, represented visually as a stock and flow diagram and mathematically as a set of differential equations. The multiscale aspect refers to nested subsystems: a backup generator may be one component in the top-level representation of an installation while being modelled as a nested dynamical system with an actuator, combustion engine, and synchronous generator.

The MNS-MSD approach operationalizes the boundary delineation between installation and environment: if detailed dynamical data is available or can be synthetically generated, the MSD approach is taken, and that part of the system is considered within the installation. If data is limited to topological network structure, then MNS is selected, and those components are considered part of the environment. In this way, MNS-MSD fully leverages data from multiple sources without loss in fidelity and is able to simulate installations and infrastructure systems simultaneously.

Example embodiments include method of evaluating operation of an installation. A first data set, describing characteristics of an environment associated with the installation, is obtained. A multiplex network science (MNS) model of the environment and the installation is generated, the MNS model integrating the first data set and representing infrastructure of the environment and the installation as a plurality of nodes connected by links, the links defining dependencies between the plurality of nodes. A second data set, describing characteristics and operation of the installation, is obtained. A multiscale system dynamics (MSD) model of the installation is then generated, the MSD model integrating the second data set and representing the installation as a plurality of nested subsystems and resource flows connecting the nested subsystems. A hybrid model integrating the MNS model and the MSD model is generated, the hybrid model linking the MNS model and MSD model via boundary conditions representing dependencies between the installation and the infrastructure of the environment. The hybrid model is then implemented to simulate 1) an alteration to the infrastructure of the environment, and 2) propagation of effects of the alteration through at least one of the boundary conditions to the installation.

The hybrid model may be further implemented to simulate 1) a change to at least one of the plurality of nested subsystems and 2) propagation of effects of the alteration to at least one other of the plurality of nested subsystems. A change in performance of the installation as a result of the propagation may also be simulated via the hybrid model. The hybrid model may also be implemented to simulate 1) a change to the nested subsystems, and 2) a change in performance of the installation resulting from both the change to the nested subsystems and the alteration.

The MSD model may represent a time-dependent functionality of the installation. The resource flows may each represent a respective flow of resources between the plurality of nested subsystems. The alteration may be a failure of the infrastructure. A modification to the installation that prevents an adverse effect caused by the alteration may be identified via simulation of the hybrid model. The installation may then be modified in accordance with the modification.

Further embodiments include a non-transitory computer-readable medium storing instructions that, when executed by a computer, cause the computer to perform some or all of the operations described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a diagram of a multiplex network science (MNS) model of an environment with an embedded installation in one embodiment.

FIG. 2 is a diagram of a multiscale system dynamics (MSD) model of an installation in one embodiment.

FIG. 3 is a diagram of a hybrid MNS-MSD model in one embodiment.

FIGS. 4A-B are diagrams of dependency relationships in one embodiment.

FIG. 5 is a diagram of an abstracted representation of a hybrid model (installation-environment network) in one embodiment.

FIG. 6 is a diagram of a boundary condition between an installation and an environment in one embodiment.

FIG. 7 is a flow diagram of a process of evaluating operation of an installation in one embodiment.

### DETAILED DESCRIPTION

A description of example embodiments follows.

An installation encompasses a multitude of infrastructural assets that, when integrated with ancillary systems such as roadways, power grids, water supply lines, and telecommunications networks, becomes an interdependent system of systems.

Domain applications of network science emphasize novel representations of real-world systems. A network representation at its most basic is expressed as a graph G=(V, E), where V is a set of vertices or nodes (e.g., rail stations, road intersections, airports, or seaports in transportation networks; species or niches in ecological networks; routers, computers, or switches in internet networks; and individuals, accounts, or organizations in social networks). E is a corresponding set of edges or links that define the connectivity between nodes (e.g., rail or road segments, flight paths, or shipping routes in transportation networks; biomass flow or species-species interactions in ecological networks; web traffic between routers in internet networks; and proximity or interaction in social networks). The flexibility of this framework allows links to represent physical flows or abstract relationships between components.

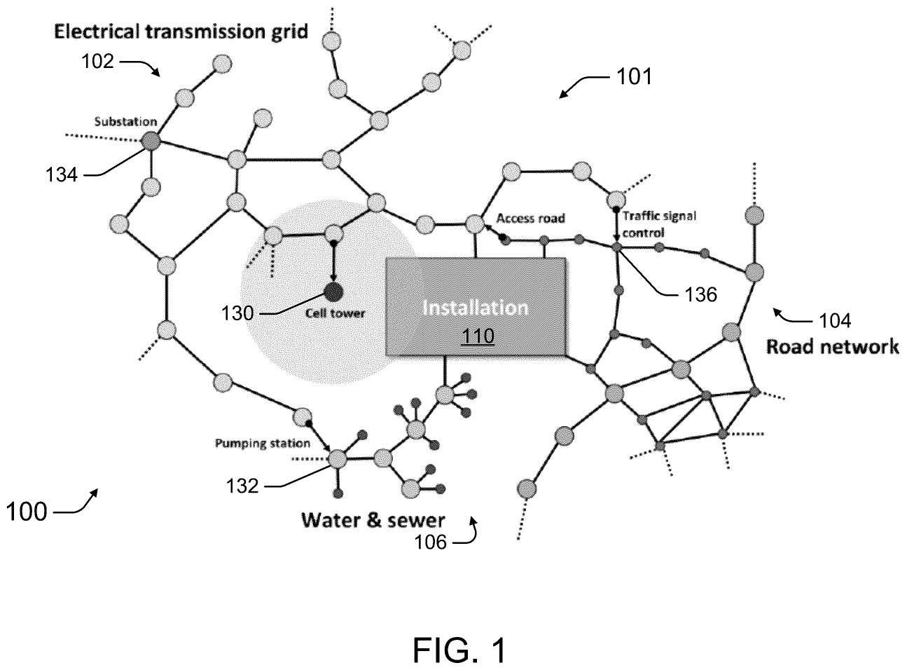

FIG. 1 is a diagram of an example multiplex network science (MNS) model 100 of an environment 101 with an embedded installation 110. MNS is a topology-based approach to modeling multiple qualitatively distinct interconnected networks simultaneously. MNS is concerned with the networks' connectivity and geospatial embedding, and with how hazards may disrupt such networks based on the structure and position of their components. MNS is a convenient modeling technique when system dynamics information is sparse, as in cases where infrastructure and installation operators have limited communication and/or data sharing capacities.

As show in FIG. 1, the MNS model 100 represents an environment 101 in which an installation 110 is embedded. The environment 101 includes an electrical grid 102, water and sewer systems 106, and a road network 104. The model 100 depicts dependencies between various components of those networks. For example, a water pumping station 132, cell tower 130, and traffic signal controller 136 depend on the electrical grid 102, while power grid repair depends on road access. The functionality of the installation 110 is reliant upon all of these infrastructure networks, which determine the installation's boundary conditions.

MNS models infrastructure systems as a directed multiplex network with m layers corresponding to the number of qualitatively distinct infrastructure systems under consideration. Bridges between layers represent directional dependencies. To simulate natural hazards, hydrologic, hurricane, storm surge, and wildfire models are used. To simulate targeted attack, network centrality measures (e.g., betweenness centrality) are used to fragment the network efficiently under attacker resource constraints. The network and disruptions are superimposed and simulated on a digital elevation model. Proxies for system functionality, such as the size of the giant connected component, are used to quantify system-wide resilience. Spatiotemporally explicit natural hazard models allow for different simulation timeframes and geographic extents and allow for scenarios where multiple hazards commence at different times during the simulation. Recovery is then simulated during or after disruption, again using network centrality measures for sequence prioritization. Network components disconnected from a source, or in lieu of a source the giant connected component, are considered secondary failures. If an installation is disconnected from an infrastructure network, its boundary conditions are altered.

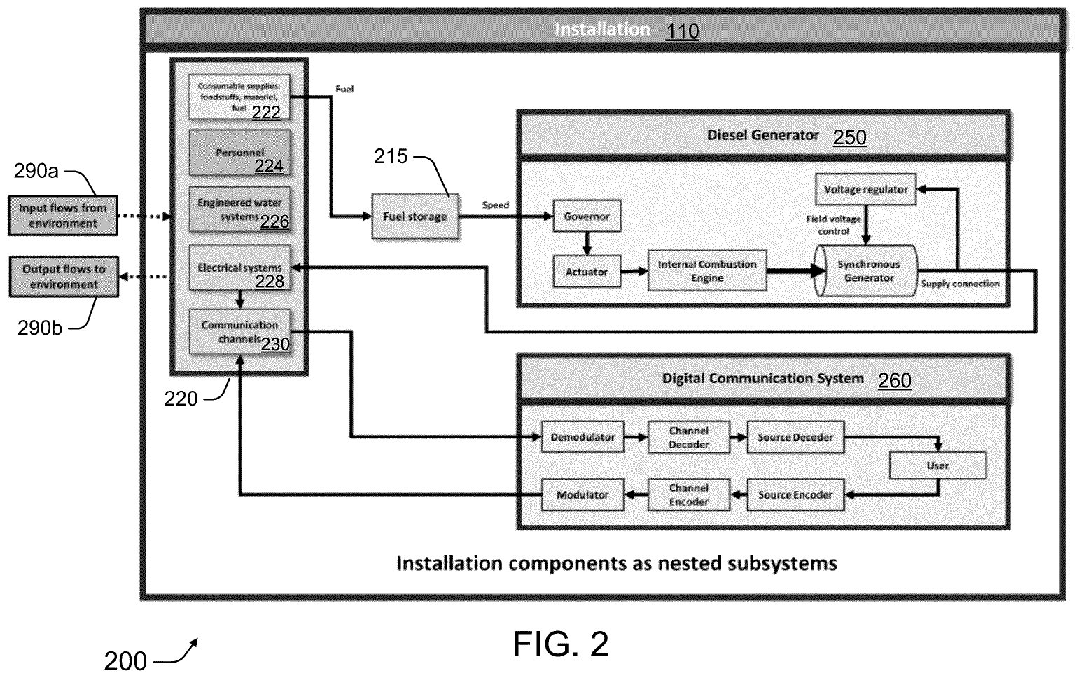

FIG. 2 is a diagram of a multiscale system dynamics (MSD) model 200 of the installation 110 in one embodiment. MSD is an approach that models an installation as a collection of stocks, flows, and feedback loops between subsystems, often represented visually by causal loop diagrams and expressed mathematically as a system of differential equations. The multiscale aspect of MSD refers to the modeling of nested subsystems within a larger installation: a system is composed of subsystems, each containing a smaller scale of nested subsystems. MSD is effective at capturing the complex nonlinear behavior of systems, enabling operators to make interventions altering system behavior. MSD may be optimal in an information-rich environment, with resource flow data either empirically sensed or synthetically generated, or a combination of the two.

The MSD model 200 represents the systems 220 that make up the installation 110, including consumable supplies 222, personnel 224, water systems 226, electrical systems 228, and communications systems 230. The systems 220 are dependent on various resources from the environment 101, represented as input flows 290a, and can output various resources to the environment, represented as output flows 290b. Each of these systems, in turn, may be made up of one or more layers of nested subsystems. For illustrative purposes, FIG. 2 shows two example subsystems in further detail: a diesel generator 250 and a digital communication system 260. Each of these subsystems can be broken down into nested subsystems with differential equations governing the flow of fuel, electricity, and information. The diesel generator 250 depends on fuel storage 215 and fuel transportation networks, while the communications system 260 depends on the electrical grid and internet connectivity. These boundary conditions (dependencies) are determined by the functionality of the infrastructure networks in the environment 101; both environment 101 and installation 110 are potentially disrupted during a hazard.

MSD models the interior of an installation or set of installations. Some normative baseline functionality is established. Boundary conditions such as fuel supply, commuting personnel, electrical power, running water and sewer systems, and internal-external communication systems are directly or indirectly a function of the installation's connection to the external infrastructure environment. Installation components are modelled as sets of ordinary differential equations with variables corresponding to, for example, power, water, encoded information, and traffic flow. Disruption and recovery can be modelled as with MNS.

This configuration enables the framework to leverage high-fidelity data on the nature, location, function, resource flow, and dependency structure of installation components while simultaneously leveraging low-fidelity data on the topology and aggregate dynamics of infrastructure systems. Installation data can be augmented with synthetic data via domain knowledge and, for example, Bayesian networks or other estimation methods.

Compound extremes are defined as natural or man-made hazards that occur in close succession, either simultaneously or sequentially. One examples of compound extremes is an opportunistic cyber-physical attack on an infrastructure system occurring in the direct aftermath of a hurricane, taking advantage of the system's already-degraded state. A further example is a 1% annual probability coastal flood occurring in freezing conditions, with extreme cold amplifying the disruptive effects of the storm on coastal communities. Compound extremes are of interest because the resulting disruptions to engineered systems and human activity in general are not well-studied, and the compounding impacts may be super-linear, i.e., greater than the sum of the damage if each extreme occurred in isolation.

Macroscopic system behavior cannot be reliably predicted from the study of individual components in isolation. Example embodiments can expand the qualitative and quantitative definition of a system, relying on fewer simplifying assumptions about behavior and dependencies within and surrounding an installation.

Example embodiments utilize two distinct modeling frameworks: MNS and MSD. MNS can be used to understand the connectivity and dependency structure of interdependent and overlapping infrastructures which constitute the environment surrounding an installation, while MSD can be used to model processes and resource flows internal to an installation. Installation-environment boundary conditions are determined by MNS, while MSD determines time-dependent internal functionality.

Installations and environments can be defined as sets of infrastructural assets with no a priori distinction. Abstracted, an installation is a subgraph of the multiplex network that composes the broader environment. Installation-environment boundaries are determined by (1) the availability of qualitative and quantitative information concerning a system or subsystem, and (2) the degree of operational control a stakeholder exerts over such systems.

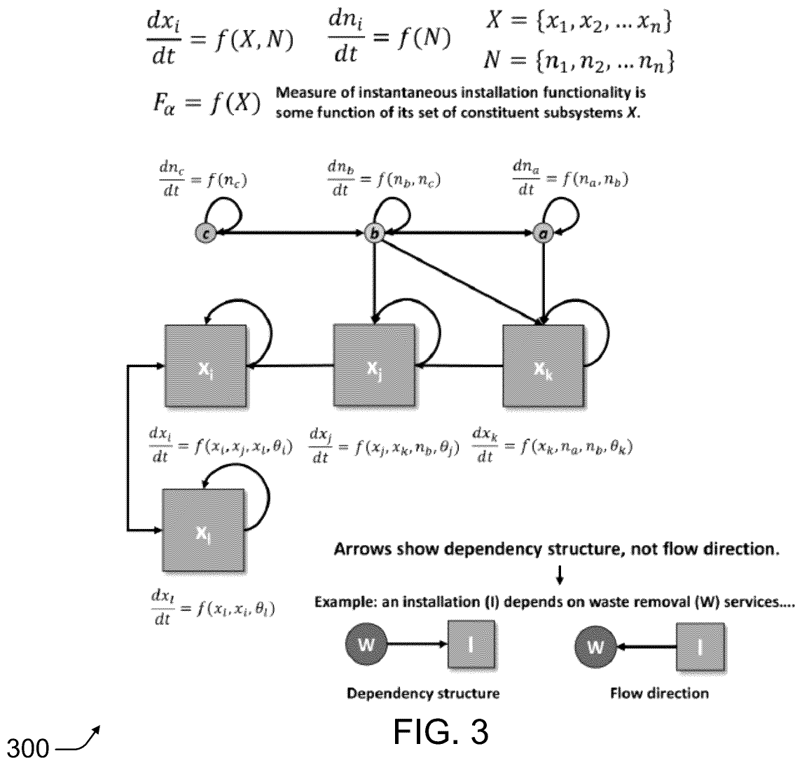

When integrated with ancillary systems including transportation, power distribution, water supply, and communication networks, the environment representation becomes a system-of-systems with complex, nonlinear, potentially bidirectional interdependencies and multiple qualitatively distinct network flows. The emergent behaviors and properties of this aggregate system are a function of the microscopic interactions between its constituent subsystems and components. Compound events in such a system can be characterized by the occurrence of two or more disruptions to normative function occurring consecutively or concurrently. This definition includes the coincidence of single extreme events with system states that exacerbate the impact of a disruption, as well as multiple low-intensity events that interact to produce synergistic, outsized impacts. To assess the resilience of a networked system to compound events, example embodiments may perform the following process:
a) Identify the components, subsystems, and (inter-) dependencies within the area of study.
b) Map the connections between components to elucidate topological structure.
c) Determine installation-environment boundaries. This is a function of data availability and operational control. When a community, layer, or component of the network corresponds to strictly topological information, it is designated as part of the environment. When resource flow-dynamical information is available or is able to be obtained from operators or stakeholders, it is designated as part of the installation. This enables abstracting the system into a multiplex network, as illustrated in FIG. 1.
d) Use system-dynamical information (e.g., mean field approximations) to assess the behavior of the system as a whole.
e) Consider a generic set of dynamical equations (e.g., FIG. 3) that capture production, transportation, and consumption in the MSD abstraction of the installation. This enables identification of feedback loops, interpretation of system behavior over time, and quantification of resilience to a given disruption by measuring system function relative to a business-as-usual baseline.

FIG. 3 illustrates a high-level representation of a hybrid MNS-MSD model 300 in one embodiment. Infrastructure network c is only dependent upon its own topological structure for sustained functionality; network b is dependent on c and itself; network a is dependent upon itself and b. Installation component (subsystem) xₖ relies on a and b as boundary conditions, its own structural integrity xₖ, and parameters θₖ. xⱼ is dependent upon xₖ, b, itself, and its parameters. xᵢ is in turn dependent upon xⱼ and xₗ, and xₗ is reciprocally dependent upon xᵢ. The state of one or more of these components can be used as a proxy for installation functionality, depending on mission objectives. Resilience can be computed by measuring functionality under disruption to functionality during normal operating conditions.

As shown in FIG. 3, arrows indicate dependencies, not necessarily flow direction. In most cases, flow and dependency will travel in the same direction, as in the case of one component providing electrical current to another. This is not always the case, however: an installation is dependent upon a sewer system, with sewage flowing in the opposite direction as the dependency relationship.

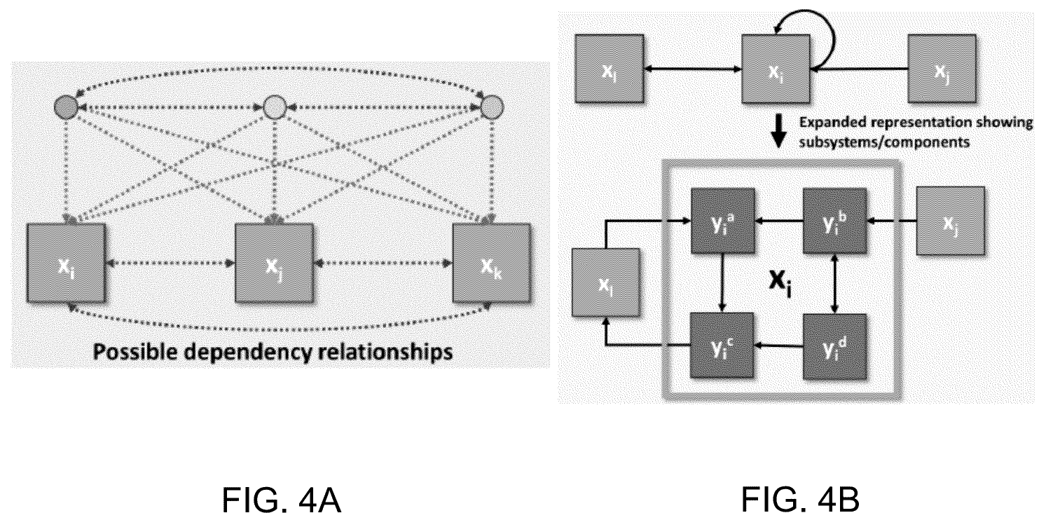

FIGS. 4A-B are diagrams of example dependency relationships. FIG. 4A shows possible dependency relationships between environmental infrastructure networks (circles at top) and subsystems of an installation x. Infrastructure networks may be bidirectionally dependent on one another, as may installation subsystems. Subsystems may be dependent upon one another, but infrastructure networks cannot be dependent upon installation subsystems. FIG. 4B shows a visual depiction of the nested nature of installation subsystems.

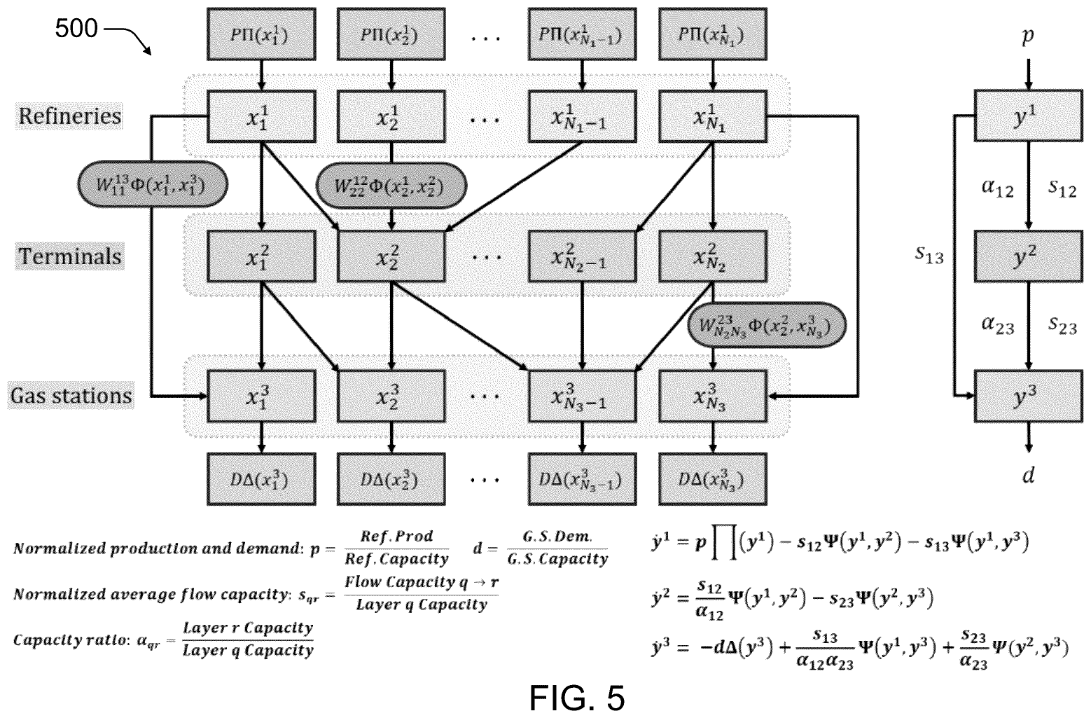

FIG. 5 illustrates an example hybrid MNS-MSD model 500 of an installation-environment network in one embodiment. San Francisco's fuel transportation network disrupted by hypothetical sea level rise scenarios is represented by this model 500. The model 500 simulates resource flow within a multiplex network. The network is multiplex because it contains two types of nodes, those representing transportation (roads, pipelines, railway, and sea) and facilities (terminals, refineries, gas stations, seaports, and airports), and (2) links representing transportation modes, with layers for rail, road, sea, and pipeline. This highlights the importance of determining boundary conditions: While the system is represented as a multiplex network, MNS is not the selected approach because dynamical information is available. Fuel storage and flow capacities were derived from data supplied by the California Energy Commission and private sector fuel production and transportation partners. Consequently, the fuel transportation network, though not an installation in the traditional sense, is as much a part of the installation as are refineries and gas stations. When data is abundant, the definition of an installation can include an arbitrary number of individual facilities and infrastructure networks. This dimension-reduction MSD approach is able to assess the fuel network's ability to meet demand under multiple sea level rise scenarios and timeframes. A purely topological MNS approach would be able to identify critical components and recommend adaptations but would not provide insight as to the ability to meet demand under sea level rise, or survival time following production disruptions.

A dimension-reduction approach was developed with the objective of modeling complex system-level behavior within an infrastructure network. This was accomplished through a functional mapping of high-dimensional system dynamics to low-dimensional representations, condensing network flow dynamics described by over 3,400 equations to just 3, expressing the average dynamics of the system while capturing macroscopic behavior. This approach allows for a simplification of dynamics without losing topological information. p is normalized production capacity, d is normalized maximum suppliable demand, s_{qr} is normalized average flow capacity between two layers q and r, and α_{qr} is the stock capacity ratio between layers q and r. Π(y¹) is the average production level for the refinery layer, Ψ(y^{q}, y^{r}) is the average flow level from layer q to layer r, and Δ(y³) is the average fuel demand in the gas station layer.

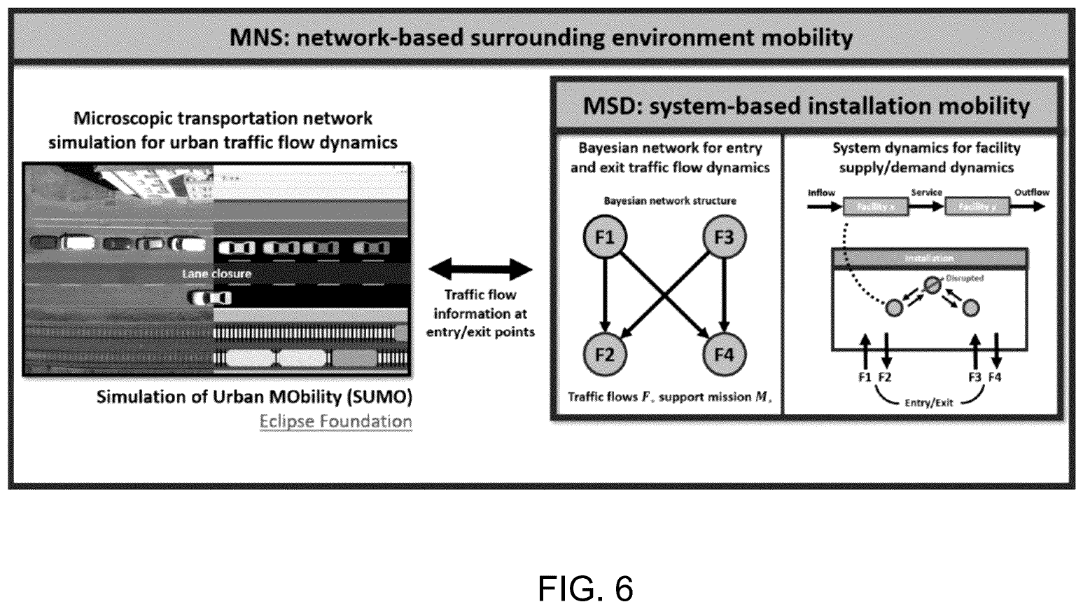

FIG. 6 is a diagram of a boundary condition between an installation and an environment in one embodiment. This diagram shows one possible MNS-MSD configuration using MNS for road and rail transportation networks and MSD for an installation. Shown on the left is Simulation of Urban Mobility (SUMO), an open-source transportation simulation software developed by the Eclipse Foundation. SUMO allows for microscopic transportation network simulations for traffic flow dynamics in the vicinity of an installation, including in urban environments with highly complex multimodal transportation systems. The flexibility of SUMO allows for simulating various disruption scenarios, such as lane closures, slowdowns due to flooding, and man-made hazards. On the right is an installation with two entry points (F1, F3) and two exit points (F2, F4). A Bayesian network model is constructed to model entry and exit traffic flows between the installation and environment. SUMO can be used to simulate boundary conditions for the installation, a concept central to the MNS-MSD framework

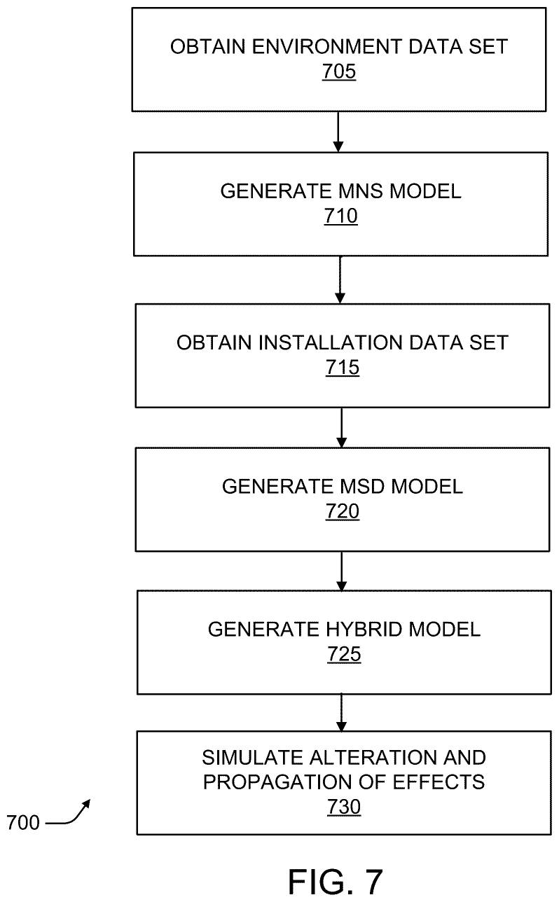

FIG. 7 is a flow diagram of a process 700 of evaluating operation of an installation in one embodiment, which may incorporate some or all of the features and operations described above. A first data set, describing characteristics of an environment associated with the installation, is obtained (705). A multiplex network science (MNS) model of the environment and the installation, such as the model 100 described above with reference to FIG. 1, is generated (710). The MNS model may integrate the first data set and may represent infrastructure of the environment and the installation as a plurality of nodes connected by links, the links defining dependencies between the plurality of nodes. A second data set, describing characteristics and operation of the installation, is obtained (715). A multiscale system dynamics (MSD) model of the installation, such as the model 200 described above with reference to FIG. 2, is then generated. The MSD model may integrate the second data set and may represent the installation as a plurality of nested subsystems and resource flows connecting the nested subsystems. A hybrid model integrating the MNS model and the MSD, such as the models 300, 500 described above with reference to FIGS. 3 and 5, is generated (725). The hybrid model may link the MNS model and MSD model via boundary conditions representing dependencies between the installation and the infrastructure of the environment. The hybrid model may then be implemented to simulate 1) an alteration to the infrastructure of the environment, and 2) propagation of effects of the alteration through at least one of the boundary conditions to the installation (730). The hybrid model may be further implemented to simulate 1) a change to at least one of the plurality of nested subsystems and 2) propagation of effects of the alteration to at least one other of the plurality of nested subsystems. A change in performance of the installation as a result of the propagation may also be simulated via the hybrid model. The hybrid model may also be implemented to simulate 1) a change to the nested subsystems, and 2) a change in performance of the installation resulting from both the change to the nested subsystems and the alteration.

Example embodiments provide several features that, alone or in combination, distinguish from typical modeling approaches:
a) Operationalization of environment-installation system boundary delineation.
b) Simultaneous modeling of information-sparse environments and information dense installations.
c) System-wide resilience quantification of both infrastructure networks and installation dynamics during compound extremes and post-disaster recovery, considering both instantaneous and marginal measures of resilience.
d) An application-agnostic framework enabling the representation of a broad range of installations and environments.
e) A scale-agnostic framework enabling the consideration of individual installation component dynamics and regional infrastructure networks (e.g., the function of a backup generator and the transportation pipelines supplying diesel fuel are modeled simultaneously).

The hybrid modeling provided in example embodiments benefits from both MNS and MSD modeling frameworks. By representing an operational environment with MNS and an installation with MSD, practitioners and stakeholders are able to accommodate diverse informational landscapes, whether the objective is understanding systems with interdependent components and subsystems or constraining potentially compounding threat spaces.

Existing methods for understanding infrastructure resilience can be categorized into four main approaches:
a) system-based semi-quantitative
b) network-based quantitative
c) quantitative
d) semi-quantitative

System-based semi-quantitative approaches use tools including fuzzy logic, Bayesian networks, agent-based modeling, and system dynamics. Network-based quantitative approaches are used to assess the physical dimensions of infrastructure resilience, relying on historical data and mathematical optimization. Quantitative approaches analyze resilience in technical and economic dimensions, requiring quantifiable resilience indicators and abundant data. Semi-quantitative approaches rely on information generated from consulting reliable sources, measuring resilience in organizational or governance dimensions.

Such existing approaches require expert input to determine the most suitable of the four, considering data availability, threat space, and the nature of the systems under consideration. The limitation of these approaches is that they are mutually exclusive. If some datasets are information-rich and others are information-sparse, one must either choose a less data-dependent method or undertake a scenario-specific data generation process requiring domain expertise. The former fails to leverage all available data to the maximum possible extent, while the latter is costly and time-consuming. Taking multiple approaches in isolation allows for the consideration of multiple analytical dimensions, but coming to conclusions that require integration of the results of each is non-trivial and difficult to validate.

When a hazard occurs, it does not disrupt systems in isolation, and damage does not stop at the boundary between infrastructure networks and installations. Hybrid models integrating MNS and MSD can accurately model the potentially complex interactions between infrastructural environments and internal operational installation environments when subject to compound hazards. In existing approaches only one of these is analyzed, treating the other side of the system boundary as a black box. This is prohibitive for studying installation-environment interactions, and studying the two in isolation does not allow for resilience quantification of the system as a whole.

An advantage of MNS-MSD over existing approaches is the maximal utilization of all available data within a single approach. Example embodiments may use system dynamics (system-based semi-quantitative) when data availability is high and network-based quantitative approaches when data availability is low. The flexibility of MSD allows for the consideration of organizational, economic, and social dimensions as information becomes available. FIG. 5 demonstrates a MNS-MSD configuration with an installation dependent on a surrounding transportation network. Possessing only network topology, a microscopic transportation network simulator is used to construct traffic flow boundary conditions for entry points to the installation, a network-based quantitative approach. Traffic flow within the installation is modeled using a Bayesian network, in turn supplying exit boundary conditions for the transportation simulation. This is a system-based semi-quantitative approach. The two approaches were selected based on data availability, operationalizing method selection and combining methods to maximally leverage data.

Thus, example embodiments provide several advantages over existing modeling, including:
a) Addressing the inability to capture interactions and dependencies of multiple systems when modelled in isolation.
b) Allowing for the explicit modelling/quantification of observed resilience-efficiency tradeoffs for more informed decision-making.
c) Fully utilizing all available data without the need for omission or aggregation.
d) Enabling actionable insights for stakeholders on 3 different time horizons: (1) hours to weeks: emergency response strategy/resource allocation; (2) months to years: hardening of specific installation/infrastructure components to increase resilience, installation of redundancies (e.g., backup generators, storage tanks); (3) years to decades: planning of new installations and infrastructure networks and/or extension of extant ones, with resilience “baked in” via network structure and strategic structural/functional redundancies.

Current approaches do not consider compound disruptions, nor do they consider a detailed, dynamical representation of an installation simultaneous with networked infrastructure systems over potentially large geographic areas. Modelling just one of the two is insufficient in terms of accurately and confidently assessing risk and resilience, and modelling the two in isolation and then integrating results fails to capture interactions and dependencies.

Example embodiments may be utilized in a range of different commercial applications. The web of dependencies and interactions within an enterprise can be mapped and analyzed, uncovering vulnerabilities and strengths across diverse functional units and stakeholders. Additionally, MNS-MSD hybrid modeling enables the identification of critical components within an organization, measuring component-level importance for system-level resilience, useful for resource allocation and intervention prioritization.

Such embodiments facilitate scenario testing and simulation, allowing organizations to model the impact of different disruptions, changes, or interventions. By combining these methodologies, enterprise-level resilience quantification becomes a dynamic and adaptable process, capable of evolving with a changing organizational, operational, and economic environment. It provides a structured framework for decision-makers to assess, strengthen, and adapt their operations in the face of uncertainty, enhance organizational agility, and better equip entities to withstand disruptions in an increasingly complex threat space.

Among the practical applications are the strengthening of resilience in critical infrastructure systems integral to urban planning and risk evaluation. This approach enables businesses to balance efficiency and resilience in complex, interconnected distribution networks, identify critical nodes and links, optimize inventory management, and develop strategies for adapting to disruptions or changes in the supply chain under uncertainty. Urban planners benefit by gaining insights as to the prioritization of retrofitting and reinforcing infrastructure components, positioning cities to better tackle long-term challenges and rapid post-disaster response. Financial institutions can model asset and liability interdependence, better gauge the ramifications of financial shocks, devise measures to bolster operational resilience, and better characterize risk in municipal bond markets. Utilities can assess the robustness of their power, water, and communication systems, identify weak points, and strategize for system enhancements and diversification. The commercial applications of MNSMSD span diverse sectors, strengthen decision-making abilities, increase the efficiency of resource allocation, and contribute to strategic foresight, all of which are facets of a comprehensive definition of resilience.

Thus, example embodiments may be implemented in the following example applications:
a) Assessing the resilience and aiding in the planning of public infrastructure (e.g., an international airport connected to power, fuel, transportation, and communication systems).
b) Ensuring sustained mission-critical functionality of defense installations, potentially in environments with little/no jurisdiction over surrounding infrastructure systems.
c) Applications in supply chain resilience across primary, secondary, and tertiary sectors, with the simultaneous modelling of several installations within a supply chain connected and supplied by infrastructure networks.
d) Aiding in the production of climate change adaptation & preparedness studies in all above examples.
e) Increasing resilience while maintaining efficiency, and thus stability, productivity, and profitability, across public and private sector clients.
f) Developing Emergency response and recovery strategy, as well as insurance industry applications in risk assessment.

While example embodiments have been particularly shown and described, it will be understood by those skilled in the art that various changes in form and details may be made therein without departing from the scope of the embodiments encompassed or contemplated herein or in the manuscript being filed herewith.

What is claimed is:

1. A method of evaluating operation of an installation, comprising:
obtaining a first data set describing characteristics of an environment associated with the installation;
generating a multiplex network science (MNS) model of the environment and the installation, the MNS model integrating the first data set and representing infrastructure of the environment and the installation as a plurality of nodes connected by links, the links defining dependencies between the plurality of nodes;
obtaining a second data set describing characteristics and operation of the installation;
generating a multiscale system dynamics (MSD) model of the installation, the MSD model integrating the second data set and representing the installation as a plurality of nested subsystems and resource flows connecting the nested subsystems;
generating a hybrid model integrating the MNS model and the MSD model, the hybrid model linking the MNS model and MSD model via boundary conditions representing dependencies between the installation and the infrastructure of the environment; and
simulating, via the hybrid model, 1) an alteration to the infrastructure of the environment, and 2) propagation of effects of the alteration through at least one of the boundary conditions to the installation.

2. The method of claim 1, further comprising simulating, via the hybrid model, 1) a change to at least one of the plurality of nested subsystems and 2) propagation of effects of the alteration to at least one other of the plurality of nested subsystems.

3. The method of claim 1, further comprising simulating, via the hybrid model, a change in performance of the installation as a result of the propagation.

4. The method of claim 1, further comprising simulating, via the hybrid model, 1) a change to the nested subsystems, and 2) a change in performance of the installation resulting from both the change to the nested subsystems and the alteration.

5. The method of claim 1, wherein the MSD model represents a time-dependent functionality of the installation.

6. The method of claim 1, wherein the resource flows each represent a respective flow of resources between the plurality of nested subsystems.

7. The method of claim 1, wherein the alteration is a failure of the infrastructure.

8. The method of claim 1, further comprising identifying, via simulation of the hybrid model, a modification to the installation that prevents an adverse effect caused by the alteration.

9. The method of claim 8, further comprising modifying the installation in accordance with the modification.

10. A non-transitory computer-readable medium storing instructions that, when executed by a computer, cause the computer to:
obtain a first data set describing characteristics of an environment associated with the installation;
generate a multiplex network science (MNS) model of the environment and the installation, the MNS model integrating the first data set and representing infrastructure of the environment and the installation as a plurality of nodes connected by links, the links defining dependencies between the plurality of nodes;
obtain a second data set describing characteristics and operation of the installation;
generate a multiscale system dynamics (MSD) model of the installation, the MSD model integrating the second data set and representing the installation as a plurality of nested subsystems and resource flows connecting the nested subsystems;
generate a hybrid model integrating the MNS model and the MSD model, the hybrid model linking the MNS model and MSD model via boundary conditions representing dependencies between the installation and the infrastructure of the environment; and
simulate, via the hybrid model, 1) an alteration to the infrastructure of the environment, and 2) propagation of effects of the alteration through at least one of the boundary conditions to the installation.

11. The computer-readable medium of claim 10, further comprising instructions to simulate, via the hybrid model, 1) a change to at least one of the plurality of nested subsystems and 2) propagation of effects of the alteration to at least one other of the plurality of nested subsystems.

12. The computer-readable medium of claim 10, further comprising instructions to simulate, via the hybrid model, a change in performance of the installation as a result of the propagation.

13. The computer-readable medium of claim 10, further comprising instructions to simulate, via the hybrid model, 1) a change to the nested subsystems, and 2) a change in performance of the installation resulting from both the change to the nested subsystems and the alteration.

14. The computer-readable medium of claim 10, wherein the MSD model represents a time-dependent functionality of the installation.

15. The computer-readable medium of claim 10, wherein the resource flows each represent a respective flow of resources between the plurality of nested subsystems.

16. The computer-readable medium of claim 10, wherein the alteration is a failure of the infrastructure.

17. The computer-readable medium of claim 10, further comprising instructions to identify, via simulation of the hybrid model, a modification to the installation that prevents an adverse effect caused by the alteration.

18. The computer-readable medium of claim 17, further comprising instructions to modify the installation in accordance with the modification.
